(19) United States
(12) Patent Application Publication
(10) Pub. No.: US 2024/0186556 A1
(43) Pub. Date: Jun. 6, 2024

(54) CO-EXTRUDED NEGATIVE ELECTRODE SPACER

(71) Applicant: ESS TECH, INC., Wilsonville, OR (US)

(72) Inventor: Sean Casey, Oregon City, OR (US)

(21) Appl. No.: 18/527,038

(22) Filed: Dec. 1, 2023

Related U.S. Application Data
(60) Provisional application No. 63/385,871, filed on Dec. 2, 2022.

(51) Int. Cl. H01M 8/18; H01M 4/88; H01M 8/0267; H01M 50/489

(52) U.S. Cl. CPC H01M 8/188; H01M 4/8864; H01M 4/8882; H01M 4/8896; H01M 8/0267; H01M 50/489

(57) ABSTRACT

Systems and methods are provided for an electrode assembly. In one example, a method for fabricating the electrode assembly includes co-extruding a first layer, comprising a conductive thermoplastic, with a second layer, comprising a nonconductive thermoplastic, to form a stack. The stack may be pressed between a set of rollers and cooled to provide a bipolar plate with an integrated negative electrode spacer bonded to a surface of the bipolar plate.

### CROSS REFERENCE TO RELATED APPLICATIONS

The present application claims priority to U.S. Provisional Application No. 63/385,871 entitled CO-EXTRUDED NEGATIVE ELECTRODE SPACER filed Dec. 2, 2022. The entire content of the above application is hereby incorporated by reference for all purposes.

### FIELD

The present description relates generally to electrode assemblies for redox flow battery systems.

### BACKGROUND AND SUMMARY

Redox flow batteries are suitable for grid scale storage applications due to their capability for scaling power and capacity independently, as well as for charging and discharging over thousands of cycles with reduced performance losses in comparison to conventional battery technologies. An all-iron hybrid redox flow battery is particularly attractive due to incorporation of low cost, earth-abundant materials. The iron redox flow battery (IFB) relies on iron, salt, and water for electrolyte, thus comprising simple, earth abundant, and inexpensive materials and eliminates incorporation of harsh chemicals, thereby allowing the IFB to impose minimal negative impact on the environment.

An electrochemical cell of the IFB may include a positive electrode, a membrane separator, a negative electrode, and a bipolar plate, arranged in a stack. The bipolar plate is positioned between the negative electrode and a first face of the positive electrode and the membrane separator is positioned between a second, opposite face of the positive electrode and a negative electrode of an adjacent cell. The negative electrode may be configured as a spacer along a negative side of the bipolar plate to provide space, e.g., volume for electrolyte to flow therethrough, and may be formed as a separate component from the bipolar plate. As such, positioning of the negative electrode spacer along a surface of the bipolar plate is demanded during assembly of the electrochemical cell.

In some instances, the negative electrode spacer may be poorly aligned with the bipolar plate during placement. For example, ribs on the negative electrode spacer may be placed on the bipolar plate such that the ribs are not parallel with one another, or not parallel with a direction of electrolyte flow across the bipolar plate. In yet other examples, the negative electrode spacer may not be positioned on the bipolar plate at all, due to operational errors. Non-optimal positioning or omission of the negative electrode spacer may lead to issues such as electrical shorting, insufficient compression of the positive electrode to moderate electrolyte flow therethrough, and poor battery performance. Furthermore, separate fabrication of the negative electrode spacer and associated time and labor demands for suitably positioning the negative electrode spacer on the bipolar plate may add to manufacturing costs.

In one example, the issues described above may be at least partially addressed by a method for manufacturing an electrode assembly, including co-extruding a first layer, comprising a conductive thermoplastic, with a second layer, comprising a nonconductive thermoplastic, to form a stack, and passing the stack between a set of chilling rollers. The method further includes cooling the stack to provide a bipolar plate with an integrated negative electrode spacer bonded to a surface of the bipolar plate. In this way, manufacturing of the battery cell may be simplified and production costs may be reduced while allowing for enhanced control over negative electrode spacer placement and associated effects on electrolyte flow.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of an example redox flow battery system which may include a bipolar plate co-extruded with a negative electrode spacer.

FIG. 2 shows a first example of a system for co-extruding a negative electrode spacer with a bipolar plate.

FIG. 3 shows an example of a bipolar plate co-extruded with a negative electrode spacer via the system of FIG. 2.

FIG. 4 shows a detailed view of a surface of the bipolar plate of FIG. 3.

FIG. 5 shows a second example of a system for co-extruding a negative electrode spacer with a bipolar plate.

FIG. 6 shows an example of a bipolar plate co-extruded with a negative electrode spacer via the system of FIG. 5.

FIG. 7 shows a third example of a system for co-extruding a negative electrode spacer with a bipolar plate.

FIG. 8 shows a cross-sectional view of an electrode assembly including a bipolar plate co-extruded with a negative electrode spacer.

FIG. 9 shows an example of a method for manufacturing an electrode assembly including a bipolar plate with an integrated negative electrode spacer.

### DETAILED DESCRIPTION

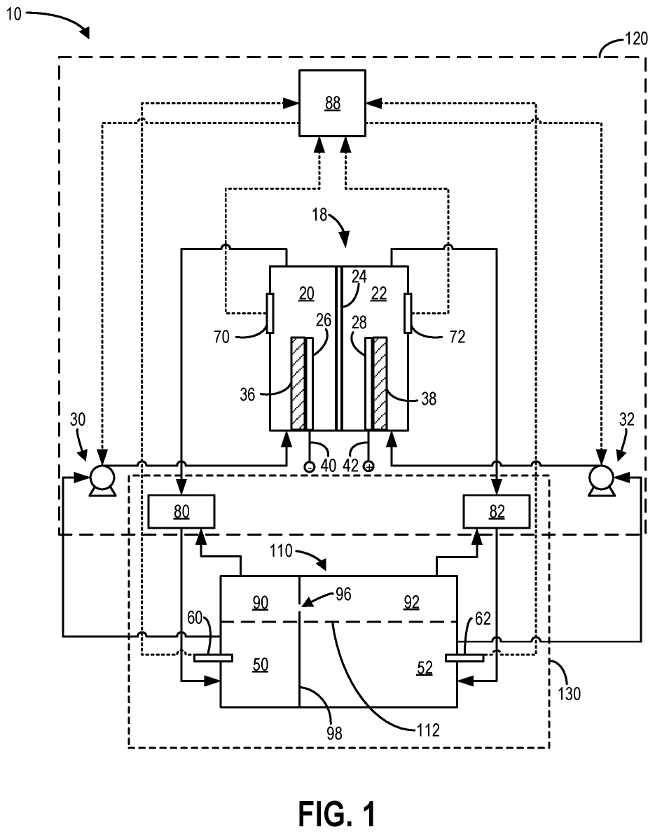

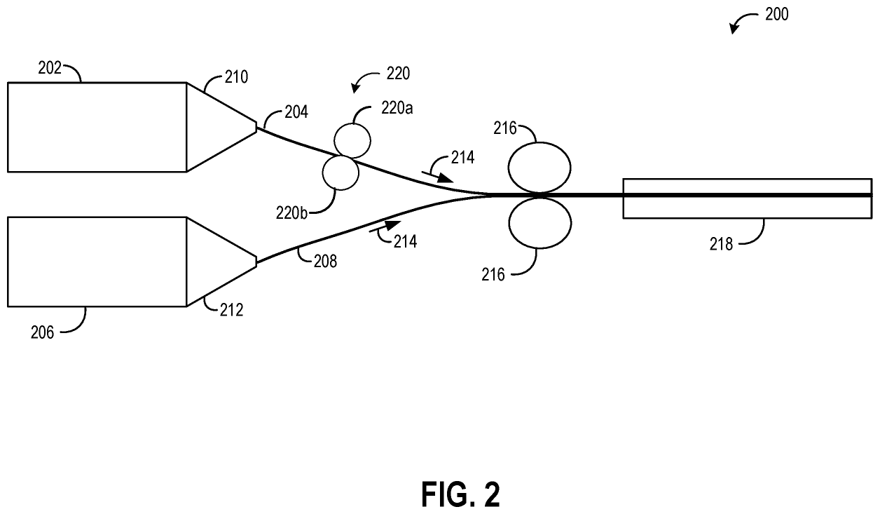

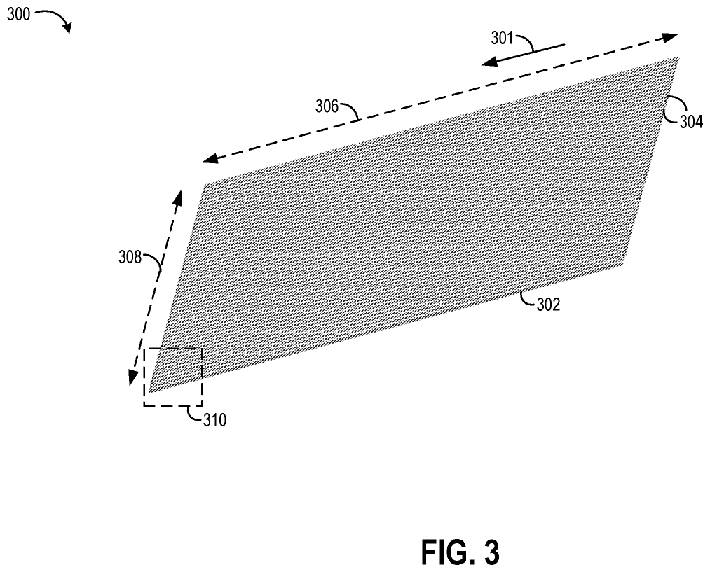

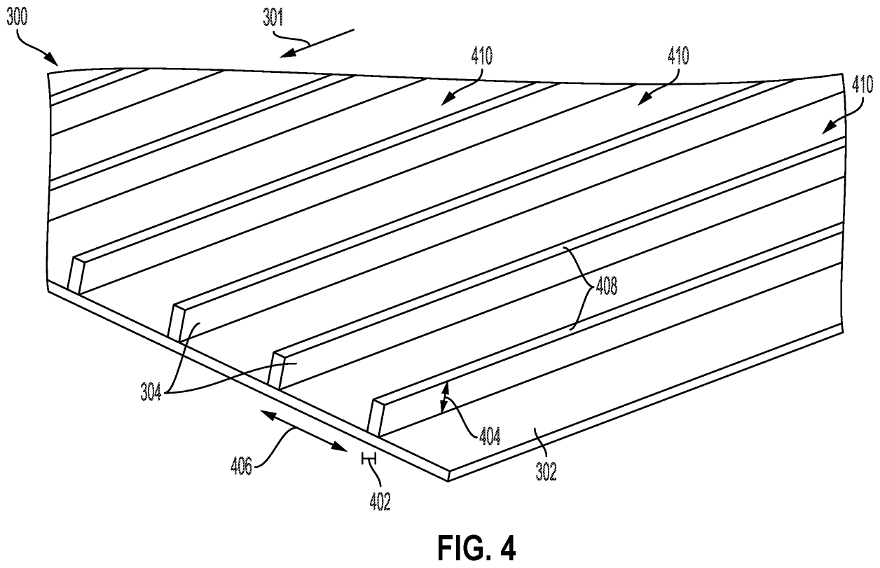

The following description relates to systems and methods for manufacturing a battery cell for a redox flow battery system. The redox flow battery system is shown in FIG. 1 with a battery cell having positive and negative electrode compartments separated by a membrane and including at least one bipolar plate. In some examples, a negative electrode of the battery cell may in face sharing contact with a spacer (e.g., negative electrode spacer) in direct contact with the bipolar plate and by fabricating the bipolar plate and spacer of the battery cell in combination, a more robust manufacturing process for the battery cell may be achieved. For example, the bipolar plate and the negative electrode spacer may be formed using a first example depicted in FIG. 2 of a system for co-extruding the bipolar plate and the negative electrode spacer. The system of FIG. 2 may enable fabrication of a bipolar plate with an integrated negative electrode spacer as illustrated in FIG. 3 and shown in greater detail in FIG. 4.

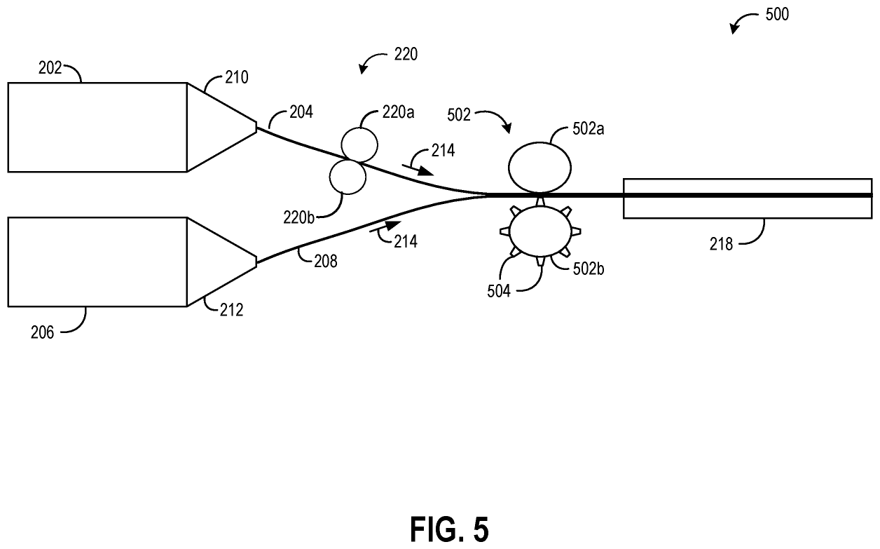

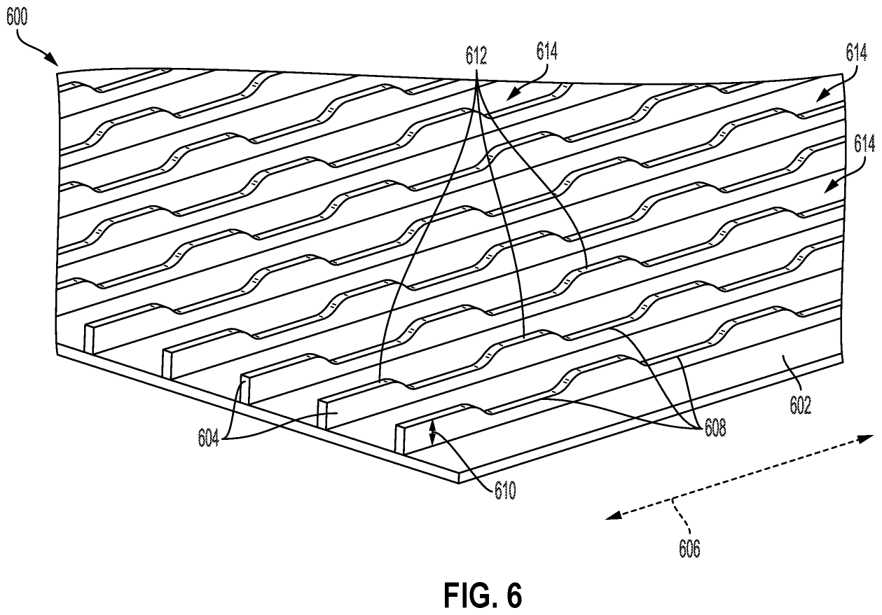

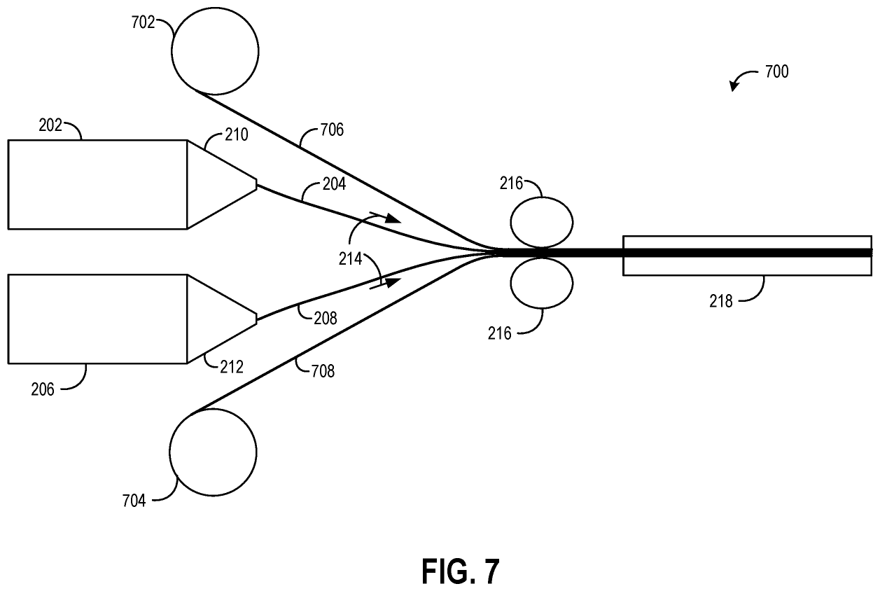

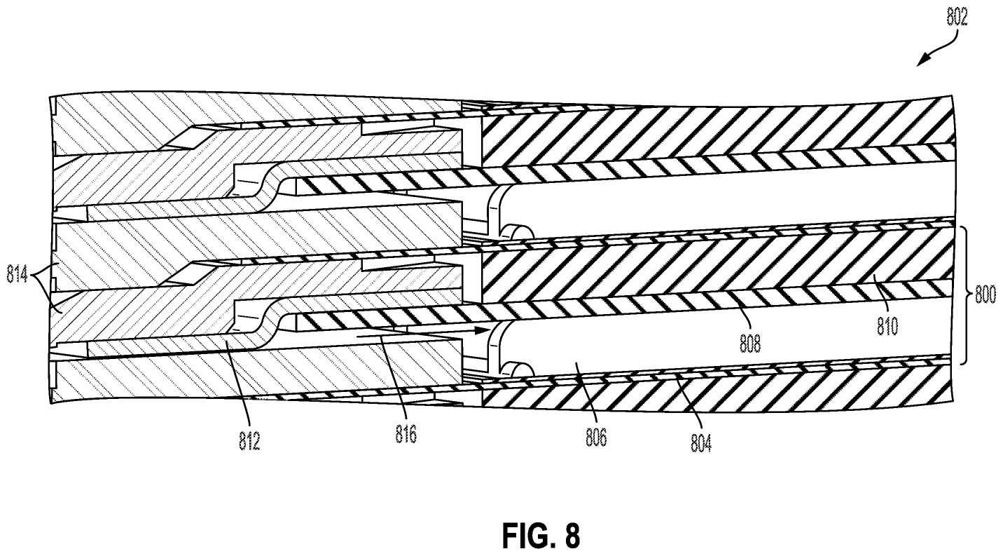

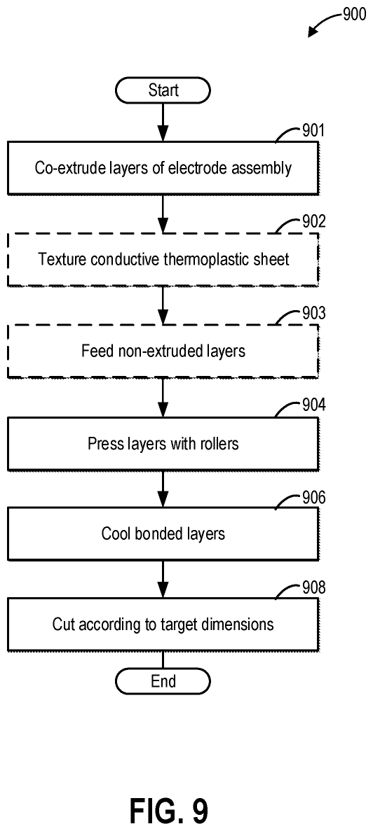

Flow distribution across the bipolar plate may be modulated by adapting the negative electrode spacer with non-linear upper edges, thereby enabling electrolyte exchange across channels formed by the negative electrode space. Modification of the negative electrode spacer geometry may be provided by a second example shown in FIG. 5 of a system for co-extruding a bipolar plate with a negative electrode spacer. Details of a bipolar plate with an integrated and modified negative electrode spacer fabricated by the system of FIG. 5 are illustrated in FIG. 6. Additionally, in some examples, production efficiency may be further increased and costs further reduced by co-extruding multiple components of a battery cell during fabrication. An example of a system for co-extruding a bipolar plate, a negative electrode spacer, a positive electrode, and a membrane separator of the battery cell is depicted in FIG. 7. A cross-sectional view of a resulting electrode assembly is shown in FIG. 8. A method for manufacturing an electrode assembly is shown in FIG. 9, the method including processes for fabricating a bipolar plate with an integrated negative electrode spacer using any of the systems shown in FIGS. 2, 5, and 7.

Turning first to FIG. 1, in a redox flow battery system 10, a negative electrode 26 may be referred to as a plating electrode and a positive electrode 28 may be referred to as a redox electrode. A negative electrolyte within a plating side (e.g., a negative electrode compartment 20) of a redox flow battery cell 18 may be referred to as a plating electrolyte, and a positive electrolyte on a redox side (e.g., a positive electrode compartment 22) of the redox flow battery cell 18 may be referred to as a redox electrolyte.

“Anode” refers to an electrode where electroactive material loses electrons and “cathode” refers to an electrode where electroactive material gains electrons. During battery charge, the negative electrolyte gains electrons at the negative electrode 26, and the negative electrode 26 is the cathode of the electrochemical reaction. During battery discharge, the negative electrolyte loses electrons, and the negative electrode 26 is the anode of the electrochemical reaction. Alternatively, during battery discharge, the negative electrolyte and the negative electrode 26 may be respectively referred to as an anolyte and the anode of the electrochemical reaction, while the positive electrolyte and the positive electrode 28 may be respectively referred to as a catholyte and the cathode of the electrochemical reaction. During battery charge, the negative electrolyte and the negative electrode 26 may be respectively referred to as the catholyte and the cathode of the electrochemical reaction, while the positive electrolyte and the positive electrode 28 may be respectively referred to as the anolyte and the anode of the electrochemical reaction. For simplicity, the terms “positive” and “negative” are used herein to refer to the electrodes, electrolytes, and electrode compartments in redox flow battery systems.

One example of a hybrid redox flow battery is an all-iron redox flow battery (IFB), in which the electrolyte includes iron ions in the form of iron salts (e.g., FeCl₂, FeCl₃, and the like), wherein the negative electrode 26 includes metal iron. For example, at the negative electrode 26, ferrous iron (Fe²⁺) gains two electrons and plates as iron metal (Fe⁰) onto the negative electrode 26 during battery charge, and Fe⁰ loses two electrons and re-dissolves as Fe²⁺ during battery discharge. At the positive electrode 28, Fe²⁺ loses an electron to form ferric iron (Fe³⁺) during battery charge, and Fe³⁺ gains an electron to form Fe²⁺ during battery discharge. The electrochemical reaction is summarized in equations (1) and (2), wherein the forward reactions (left to right) indicate electrochemical reactions during battery charge, while the reverse reactions (right to left) indicate electrochemical reactions during battery discharge:

Fe²⁺+2c⁻↔Fe⁰ −0.44 V (negative electrode) (1)

2Fe²⁺↔2Fe³⁺+2e⁻ +0.77 V (positive electrode) (2)

As discussed above, the negative electrolyte used in the IFB may provide a sufficient amount of Fe²⁺ so that, during battery charge, Fe²⁺ may accept two electrons from the negative electrode 26 to form Fe⁰ and plate onto a substrate. During battery discharge, the plated Fe⁰ may lose two electrons, ionizing into Fe²⁺ and dissolving back into the electrolyte. An equilibrium potential of the above reaction is −0.44 V and this reaction therefore provides a negative terminal for the desired system. On the positive side of the IFB, the electrolyte may provide Fe²⁺ during battery charge which loses an electron and oxidizes to Fe³⁺. During battery discharge, Fe³⁺ provided by the electrolyte becomes Fe²⁺ by absorbing an electron provided by the positive electrode 28. An equilibrium potential of this reaction is +0.77 V, creating a positive terminal for the desired system.

The IFB may provide the ability to charge and recharge electrolytes therein in contrast to other battery types utilizing non-regenerating electrolytes. Charge may be achieved by respectively applying an electric current across the negative electrode 26 and positive electrode 28 via negative battery terminal 40 and positive battery terminal 42. The negative electrode 26 may be electrically coupled via the negative battery terminal 40 to a negative side of a voltage source so that electrons may be delivered to the negative electrolyte via the positive electrode 28 (e.g., as Fe²⁺ is oxidized to Fe³⁺ in the positive electrolyte in the positive electrode compartment 22). The electrons provided to the negative electrode 26 may reduce the Fe²⁺ in the negative electrolyte to form Fe⁰ at the (plating) substrate, causing the Fe²⁺ to plate onto the negative electrode 26.

Discharge may be sustained while Fe⁰ remains available to the negative electrolyte for oxidation and while Fe³⁺ remains available in the positive electrolyte for reduction. As an example, Fe³⁺ availability may be maintained by increasing a concentration or a volume of the positive electrolyte in the positive electrode compartment 22 side of the redox flow battery cell 18 to provide additional Fe³⁺ ions via an external source, such as an external positive electrolyte chamber 52. More commonly, availability of Fe⁰ during discharge may be an issue in IFB systems, wherein the Fe⁰ available for discharge may be proportional to a surface area and a volume of the negative electrode substrate, as well as to a plating efficiency. Charge capacity may be dependent on the availability of Fe²⁺ in the negative electrode compartment 20. As an example, Fe²⁺ availability may be maintained by providing additional Fe²⁺ ions via an external source, such as an external negative electrolyte chamber 50 to increase a concentration or a volume of the negative electrolyte to the negative electrode compartment 20 side of the redox flow battery cell 18.

In an IFB, the positive electrolyte may include ferrous iron, ferric iron, ferric complexes, or any combination thereof, while the negative electrolyte may include ferrous iron or ferrous complexes, depending on a state of charge (SOC) of the IFB system. As previously mentioned, utilization of iron ions in both the negative electrolyte and the positive electrolyte may allow for utilization of the same electrolytic species on both sides of the redox flow battery cell 18, which may reduce electrolyte cross-contamination and may increase the efficiency of the IFB system, resulting in less electrolyte replacement as compared to other redox flow battery systems.

Efficiency losses in an IFB may result from electrolyte crossover through a separator 24 (e.g., ion-exchange membrane barrier, microporous membrane, and the like). For example, Fe³⁺ ions in the positive electrolyte may be driven toward the negative electrolyte by a Fe³⁺ ion concentration gradient and an electrophoretic force across the separator 24. Subsequently, Fe³⁺ ions penetrating the separator 24 and crossing over to the negative electrode compartment 20 may result in coulombic efficiency losses. Fe³⁺ ions crossing over from the low pH redox side (e.g., more acidic positive electrode compartment 22) to the high pH plating side (e.g., less acidic negative electrode compartment 20) may result in precipitation of Fe(OH)₃. Precipitation of Fc(OH)₃ may degrade the separator 24 and cause permanent battery performance and efficiency losses. For example, Fe(OH)₃ precipitate may chemically foul an organic functional group of an ion-exchange membrane or physically clog micropores of the ion-exchange membrane. In either case, due to the Fe(OH)₃ precipitate, membrane ohmic resistance may rise over time and battery performance may degrade. Precipitate may be removed by washing the IFB with acid, but constant maintenance and downtime may be disadvantageous for commercial battery applications. Furthermore, washing may be dependent on regular preparation of electrolyte, contributing to additional processing costs and complexity. Alternatively, adding specific organic acids to the positive electrolyte and the negative electrolyte in response to electrolyte pH changes may mitigate precipitate formation during battery charge and discharge cycling without driving up overall costs. Additionally, implementing a membrane barrier that inhibits Fe³⁺ ion crossover may also mitigate fouling.

Additional coulombic efficiency losses may be caused by reduction of H⁺ (e.g., protons) and subsequent formation of H₂ gas, and a reaction of protons in the negative electrode compartment 20 with electrons supplied at the plated iron metal of the negative electrode 26 to form H₂ gas.

The IFB electrolyte (e.g., FeCl₂, FeCl₃, FeSO₄, Fe₂(SO₄)₃, and the like) may be readily available and may be produced at low costs. In one example, the IFB electrolyte may be formed from ferrous chloride (FeCl₂), potassium chloride (KCl), manganese(II) chloride (MnCl₂), and boric acid (H₃BO₃). The IFB electrolyte may offer higher reclamation value because the same electrolyte may be used for the negative electrolyte and the positive electrolyte, consequently reducing cross-contamination issues as compared to other systems. Furthermore, because of iron's electron configuration, iron may solidify into a generally uniform solid structure during plating thereof on the negative electrode substrate. For zinc and other metals commonly used in hybrid redox batteries, solid dendritic structures may form during plating. A stable electrode morphology of the IFB system may increase the efficiency of the battery in comparison to other redox flow batteries. Further still, iron redox flow batteries may reduce the use of toxic raw materials and may operate at a relatively neutral pH as compared to other redox flow battery electrolytes. Accordingly, IFB systems may reduce environmental hazards as compared with all other current advanced redox flow battery systems in production.

Continuing with FIG. 1, a schematic illustration of the redox flow battery system 10 is shown. The redox flow battery system 10 may include the redox flow battery cell 18 fluidly coupled to an integrated multi-chambered electrolyte storage tank 110. The redox flow battery cell 18 may include the negative electrode compartment 20, separator 24, and positive electrode compartment 22. The separator 24 may include an electrically insulating ionic conducting barrier which prevents bulk mixing of the positive electrolyte and the negative electrolyte while allowing conductance of specific ions therethrough. For example, and as discussed above, the separator 24 may include an ion-exchange membrane and/or a microporous membrane.

The negative electrode compartment 20 may include the negative electrode 26, and the negative electrolyte may include electroactive materials. The positive electrode compartment 22 may include the positive electrode 28, and the positive electrolyte may include electroactive materials. In some examples, multiple redox flow battery cells 18 may be combined in series or in parallel to generate a higher voltage or electric current in the redox flow battery system 10.

Further illustrated in FIG. 1 are negative electrolyte pump 30 and positive electrolyte pump 32, both used to pump electrolyte solution through the redox flow battery system 10. Electrolytes are stored in one or more tanks external to the cell, and are pumped via the negative and positive electrolyte pumps 30 and 32 through the negative electrode compartment 20 side and the positive electrode compartment 22 side of the redox flow battery cell 18, respectively.

The redox flow battery system 10 may also include a first bipolar plate 36 and a second bipolar plate 38, each positioned along a rear-facing side, e.g., opposite of a side facing the separator 24, of the negative electrode 26 and the positive electrode 28, respectively. The first bipolar plate 36 may be in contact with the negative electrode 26 and the second bipolar plate 38 may be in contact with the positive electrode 28. In other examples, however, the first and second bipolar plates 36 and 38 may be arranged proximate but spaced away from the negative electrode 26 and positive electrode 28 and housed within the respective negative electrode compartment 20 and positive electrode compartment 22. In either case, the first and second bipolar plates 36 and 38 may be electrically coupled to the battery terminals 40 and 42, respectively, either via direct contact therewith or through the negative and positive electrodes 26 and 28, respectively. The IFB electrolytes may be transported to reaction sites at the negative and positive electrodes 26 and 28 by the first and second bipolar plates 36 and 38, resulting from conductive properties of a material of the first and second bipolar plates 36 and 38. Electrolyte flow may also be assisted by the negative and positive electrolyte pumps 30 and 32, facilitating forced convection through the redox flow battery cell 18. Reacted electrochemical species may also be directed away from the reaction sites by a combination of forced convection and a presence of the first and second bipolar plates 36 and 38.

As illustrated in FIG. 1, the redox flow battery cell 18 may further include the negative battery terminal 40 and the positive battery terminal 42. When a charge current is applied to the battery terminals 40 and 42, the positive electrolyte may be oxidized (loses one or more electrons) at the positive electrode 28, and the negative electrolyte may be reduced (gains one or more electrons) at the negative electrode 26. During battery discharge, reverse redox reactions may occur on the negative and positive electrodes 26 and 28, respectively. In other words, the positive electrolyte may be reduced (gains one or more electrons) at the positive electrode 28, and the negative electrolyte may be oxidized (loses one or more electrons) at the negative electrode 26. An electrical potential difference across the battery may be maintained by the electrochemical redox reactions in the positive electrode compartment 22 and the negative electrode compartment 20, and may induce an electric current through a current collector while the reactions are sustained. An amount of energy stored by a redox battery may be limited by an amount of electroactive material available in electrolytes for discharge, depending on a total volume of electrolytes and a solubility of the electroactive materials.

The redox flow battery system 10 may further include the integrated multi-chambered electrolyte storage tank 110. The multi-chambered electrolyte storage tank 110 may be divided by a bulkhead 98. The bulkhead 98 may create multiple chambers within the multi-chambered electrolyte storage tank 110 so that both the positive and negative electrolytes may be included within a single tank. The negative electrolyte chamber 50 holds negative electrolyte including the electroactive materials, and the positive electrolyte chamber 52 holds positive electrolyte including the electroactive materials. The bulkhead 98 may be positioned within the multi-chambered electrolyte storage tank 110 to yield a desired volume ratio between the negative electrolyte chamber 50 and the positive electrolyte chamber 52. In one example, the bulkhead 98 may be positioned to set a volume ratio of the negative and positive electrolyte chambers 50 and 52 according to a stoichiometric ratio between the negative and positive redox reactions.

FIG. 1 further illustrates a fill height 112 of the multi-chambered electrolyte storage tank 110, which may indicate a liquid level in each tank compartment. FIG. 1 also shows a gas head space 90 located above the fill height 112 of the negative electrolyte chamber 50, and a gas head space 92 located above the fill height 112 of the positive electrolyte chamber 52. The gas head space 92 may be utilized to store H₂ gas generated through operation of the redox flow battery (e.g., due to proton reduction and iron corrosion side reactions) and conveyed to the multi-chambered electrolyte storage tank 110 with returning electrolyte from the redox flow battery cell 18. The H₂ gas may be separated spontaneously at a gas-liquid interface (e.g., the fill height 112) within the multi-chambered electrolyte storage tank 110, thereby precluding having additional gas-liquid separators as part of the redox flow battery system 10. Once separated from the electrolyte, the H₂ gas may fill the gas head spaces 90 and 92. As such, the stored H₂ gas may aid in purging other gases from the multi-chambered electrolyte storage tank 110, thereby acting as an inert gas blanket for reducing oxidation of electrolyte species, which may help to reduce redox flow battery capacity losses. In this way, utilizing the integrated multi-chambered electrolyte storage tank 110 may forego having separate negative and positive electrolyte storage tanks, hydrogen storage tanks, and gas-liquid separators common to conventional redox flow battery systems, thereby simplifying a system design, reducing a physical footprint of the redox flow battery system 10, and reducing system costs.

FIG. 1 also shows a spillover hole 96, which may create an opening in the bulkhead 98 between the gas head spaces 90 and 92, and may provide a means of equalizing gas pressure between the negative and positive electrolyte chambers 50 and 52. The spillover hole 96 may be positioned at a threshold height above the fill height 112. The spillover hole 96 may further enable a capability to self-balance the electrolytes in each of the negative and positive electrolyte chambers 50 and 52 in the event of a battery crossover. In the case of an all-iron redox flow battery system, the same electrolyte (Fe²⁺) is used in both the negative electrode compartment 20 and positive electrode compartment 22, so spilling over of electrolyte between the negative and positive electrolyte chambers 50 and 52 may reduce overall system efficiency, but overall electrolyte composition, battery module performance, and battery module capacity may be maintained. Flange fittings may be utilized for all piping connections for inlets and outlets to and from the multi-chambered electrolyte storage tank 110 to maintain a continuously pressurized state without leaks. The multi-chambered electrolyte storage tank 110 may include at least one outlet from each of the negative and positive electrolyte chambers 50 and 52, and at least one inlet to each of the negative and positive electrolyte chambers 50 and 52. Furthermore, one or more outlet connections may be provided from the gas head spaces 90 and 92 for directing H₂ gas to electrolyte rebalancing reactors 80 and 82.

Although not shown in FIG. 1, the integrated multi-chambered electrolyte storage tank 110 may further include one or more heaters thermally coupled to each of the negative electrolyte chamber 50 and the positive electrolyte chamber 52. In alternate examples, one of the negative and positive electrolyte chambers 50 and 52 may include one or more heaters. In the case where the positive electrolyte chamber 52 includes one or more heaters, the negative electrolyte may be heated by transferring heat generated at the redox flow battery cell 18 to the negative electrolyte. In this way, the redox flow battery cell 18 may heat and facilitate temperature regulation of the negative electrolyte. The one or more heaters may be actuated by a controller 88 to regulate a temperature of the negative electrolyte chamber 50 and the positive electrolyte chamber 52 independently or together. For example, in response to an electrolyte temperature decreasing below a threshold temperature, the controller 88 may increase a power supplied to one or more heaters so that a heat flux to the electrolyte may be increased. The electrolyte temperature may be indicated by one or more temperature sensors mounted at the multi-chambered electrolyte storage tank 110, such as sensors 60 and 62.

Further still, one or more inlet connections may be provided to each of the negative and positive electrolyte chambers 50 and 52 from a field hydration system (not shown). In this way, the field hydration system may facilitate commissioning of the redox flow battery system 10, including installing, filling, and hydrating the redox flow battery system 10, at an end-use location. Furthermore, prior to commissioning the redox flow battery system 10 at the end-use location, the redox flow battery system 10 may be dry-assembled at a battery manufacturing facility different from the end-use location without filling and hydrating the redox flow battery system 10, before delivering the redox flow battery system 10 to the end-use location.

Further illustrated in FIG. 1, electrolyte solutions primarily stored in the multi-chambered electrolyte storage tank 110 may be pumped via the negative and positive electrolyte pumps 30 and 32 throughout the redox flow battery system 10. Electrolyte stored in the negative electrolyte chamber 50 may be pumped via the negative electrolyte pump 30 through the negative electrode compartment 20 side of the redox flow battery cell 18, and electrolyte stored in the positive electrolyte chamber 52 may be pumped via the positive electrolyte pump 32 through the positive electrode compartment 22 side of the redox flow battery cell 18.

The electrolyte rebalancing reactors 80 and 82 may be connected in line or in parallel with the recirculating flow paths of the electrolyte at the negative and positive sides of the redox flow battery cell 18, respectively, in the redox flow battery system 10. One or more rebalancing reactors may be connected in-line with the recirculating flow paths of the electrolyte at the negative and positive sides of the battery, and other rebalancing reactors may be connected in parallel, for redundancy (e.g., a rebalancing reactor may be serviced without disrupting battery and rebalancing operations) and for increased rebalancing capacity. In one example, the electrolyte rebalancing reactors 80 and 82 may be placed in a return flow path from the negative electrode compartment 20 and positive electrode compartment 22 to the negative and positive electrolyte chambers 50 and 52, respectively.

The electrolyte rebalancing reactors 80 and 82 may serve to rebalance electrolyte charge imbalances in the redox flow battery system 10 occurring due to side reactions, ion crossover, and the like, as described herein. In one example, electrolyte rebalancing reactors 80 and 82 may include trickle bed reactors, where the H₂ gas and electrolyte may be contacted at catalyst surfaces in a packed bed for carrying out the electrolyte rebalancing reaction. In other examples, the electrolyte rebalancing reactors 80 and 82 may include flow-through type reactors that are capable of contacting the H₂ gas and the electrolyte liquid and carrying out the electrolyte rebalancing reactions absent a packed catalyst bed.

During operation of the redox flow battery system 10, sensors and probes may monitor and control chemical properties of the electrolyte such as electrolyte pH, concentration, SOC, and the like. For example, as illustrated in FIG. 1, sensors 62 and 60 maybe be positioned to monitor positive electrolyte and negative electrolyte conditions at the positive electrolyte chamber 52 and the negative electrolyte chamber 50, respectively. In another example, sensors 62 and 60 may each include one or more electrolyte level sensors to indicate a level of electrolyte in the positive electrolyte chamber 52 and the negative electrolyte chamber 50, respectively. As another example, sensors 72 and 70, also illustrated in FIG. 1, may monitor positive electrolyte and negative electrolyte conditions at the positive electrode compartment 22 and the negative electrode compartment 20, respectively. The sensors 72 and 70 may be pH probes, optical probes, pressure sensors, voltage sensors, etc. It will be appreciated that sensors may be positioned at other locations throughout the redox flow battery system 10 to monitor electrolyte chemical properties and other properties.

The redox flow battery system 10 may further include a source of H₂ gas. In one example, the source of H₂ gas may include a separate dedicated hydrogen gas storage tank. In the example of FIG. 1, H₂ gas may be stored in and supplied from the integrated multi-chambered electrolyte storage tank 110. The integrated multi-chambered electrolyte storage tank 110 may supply additional H₂ gas to the positive electrolyte chamber 52 and the negative electrolyte chamber 50. The integrated multi-chambered electrolyte storage tank 110 may alternately supply additional H₂ gas to an inlet of the electrolyte rebalancing reactors 80 and 82. As an example, a mass flow meter or other flow controlling device (which may be controlled by the controller 88) may regulate flow of the H₂ gas from the integrated multi-chambered electrolyte storage tank 110.

The controller 88 may further execute control schemes based on an operating mode of the redox flow battery system 10. For example, the controller 88 may control charging and discharging of the redox flow battery cell 18 so as to cause iron preformation at the negative electrode 26 during system conditioning (where system conditioning may include an operating mode employed to optimize electrochemical performance of the redox flow battery system 10 outside of battery cycling). That is, during system conditioning, the controller 88 may adjust one or more operating conditions of the redox flow battery system 10 to plate iron metal on the negative electrode 26 to improve a battery charge capacity during subsequent battery cycling (thus, the iron metal may be preformed for battery cycling). As used herein, battery cycling (also referred to as “charge cycling”) may include alternating between a charging mode and a discharging mode of the redox flow battery system 10.

It will be appreciated that all components apart from the sensors 60 and 62 and the integrated multi-chambered electrolyte storage tank 110 (and components included therein) may be considered as being included in a power module 120. As such, the redox flow battery system 10 may be described as including the power module 120 fluidly coupled to the integrated multi-chambered electrolyte storage tank 110 and communicably coupled to the sensors 60 and 62. In some examples, each of the power module 120 and the multi-chambered electrolyte storage tank 110 may be included in a single housing (not shown), such that the redox flow battery system 10 may be contained as a single unit in a single location. It will further be appreciated the positive electrolyte, the negative electrolyte, the sensors 60 and 62, the electrolyte rebalancing reactors 80 and 82, and the integrated multi-chambered electrolyte storage tank 110 (and components included therein) may be considered as being included in an electrolyte subsystem 130. As such, the electrolyte subsystem 130 may supply one or more electrolytes to the redox flow battery cell 18 (and components included therein).

In some examples, a negative electrode, e.g., the negative electrode 26 of FIG. 1, of a battery cell may include a spacer (e.g., a negative electrode spacer) arranged between a negative side of a bipolar plate (e.g., a side exposed to negative electrolyte in a negative electrode compartment of the battery cell) and a membrane separator of the battery cell. The negative electrode spacer may be in direct contact with the negative side of the bipolar plate and the membrane separator and may be formed of a relatively rigid material to maintain a space between the bipolar plate and the membrane separator, even upon compression of the battery cell.

Electrolyte may flow in the space maintained by the negative electrode spacer and a geometry and alignment of the negative electrode spacer may therefore affect electrolyte distribution through the negative electrode compartment. For example, arrangement of the negative electrode spacer to promote flow along a longitudinal axis of the bipolar plate may be desirable for facilitating redox reactions during operation of a redox flow battery system. During manufacturing of the battery cell, however, placement of the negative electrode spacer relative to the bipolar plate may be misaligned, or spaced apart such that an electrolyte volume of the negative electrode compartment is reduced relative to a target volume, when the negative electrode spacer is a separate structure from the bipolar plate. In some examples, the negative electrode spacer may be inadvertently omitted. As a result, a likelihood of electrical shorting may be increased while a performance of the redox flow battery system, e.g., power output and cycling capacity, may be degraded.

In one example, a relative positioning of the negative electrode spacer may be maintained optimal during fabrication by forming the negative electrode spacer with the bipolar plate as a single continuous structure. For example, a process for forming the bipolar plate may be modified to incorporate the negative electrode spacer into its construction. As an example, the bipolar plate may be co-extruded with the negative electrode spacer such that the negative electrode spacer may be integrated into one surface of the bipolar plate and an alignment of the negative electrode spacer with respect to the bipolar plate may not be altered post-fabrication.

The bipolar plate may be formed of a thermoplastic composite, such as a carbon-based conductive material loaded with a thermoplastic polymer. In one example, the conductive material may be graphite and the thermoplastic polymer may be polypropylene. In other example, however, the conductive material may include titanium, stainless steel, or any other conductive element or alloy while the thermoplastic polymer may be polyphenylene sulfide (PPS), polyphenylsulfone (PPSU), polyether ether ketone (PEEK), polytetrafluoroethylene (PTFE), or perfluororalkoxy alkane (PFA), amongst others. The conductive material and the thermoplastic composite may be mixed and extruded by feeding the mixture through a die to form an extruded sheet. The extruded sheet may be cut according to desired dimensions of the bipolar plate, and coupled to other components of a bipolar plate assembly, such as a frame plate, before the bipolar plate assembly is incorporated into an electrode assembly of the battery cell.

Two or more polymer materials, having suitable chemical and/or mechanical compatibility, may be extruded together, e.g., co-extruded, to form a multilayer structure. A geometry of the negative electrode spacer may be selected according to a desired effect on electrolyte flow. For example, the negative electrode spacer may be configured as one or more ribs extending across a length of the bipolar plate, where the length is parallel with a direction of extrusion of the conductive thermoplastic sheet. A number of the ribs, a spacing between the ribs, a height and width of the ribs, as well as a profile of the ribs may be adjusted based on target operating parameters of the battery cell. The negative electrode spacer may be formed of a thermoplastic polymer with similar properties as the thermoplastic polymer of the bipolar plate. As an example, the bipolar plate may be formed of graphite loaded with polypropylene while the negative electrode spacer may be formed of polypropylene, as described above.

A first example of a system 200 for co-extruding a bipolar plate with a negative electrode spacer is shown in FIG. 2. The system 200 includes a first extruder 202 for extruding a conductive thermoplastic, such as graphite loaded with polypropylene, and a second extruder 206 for extruding a nonconductive thermoplastic, such as polypropylene. The conductive thermoplastic of the first extruder 202 may be fed through a first die 210 that forms a conductive thermoplastic sheet 204 and the nonconductive thermoplastic of the second extruder 206 may be fed through a second die 212 that forms nonconductive thermoplastic ribs 208. The first extruder 202 and the first die 210 may extrude the conductive thermoplastic sheet 204 with a width sufficiently wide to achieve a target active area of the bipolar plate, where the active area is a region of the bipolar plate in direct contact with electrolyte.

The conductive thermoplastic sheet 204 may be textured before coming into contact with the nonconductive thermoplastic ribs 208. Texturing may be achieved by passing the conductive thermoplastic sheet 204 through a set of rollers 220 following extrusion through first die 210 when the conductive thermoplastic sheet 204 is molten. The set of rollers 200 may include a smooth roller 220a and a textured roller 220b, such that a surface of the conductive thermoplastic sheet may be smoothed by the smooth roller 220a, while an opposite surface may be imprinted with the roughness of the textured roller 220b. As shown in FIG. 2, the set of rollers 220 may be oriented such that the rough roller 220b may contact the same surface of the conductive thermoplastic sheet 204 on which the nonconductive thermoplastic ribs 208 may come into contact with following texturing of the conductive thermoplastic sheet. In other words, the textured surface of the conductive thermoplastic sheet 204 may form the active area of the bipolar plate. Texturing of the conductive thermoplastic sheet 204 may increase plating adhesion and surface area of the active area. Texturing may adjust Ra (arithmetic mean roughness), RSm (arithmetic mean width of roughness profile units), of a plating surface of the conductive thermoplastic sheet 204 to above a threshold level demanded to promote even, crack free plating of iron metal onto the bipolar plate during charging of the redox flow battery. In other examples, the set of rollers 220 may be omitted such that texturing of the conductive thermoplastic sheet 204 may not occur, and instead the conductive thermoplastic sheet may be smooth on both sides as when exiting the first die 210.

Following the optional texturing of the conductive thermoplastic sheet 204, the conductive thermoplastic sheet 204 and the nonconductive thermoplastic ribs 208 may be conveyed along directions indicated by arrows 214 to be pressed against one another as they are passed through a set of chilling rollers 216 while the materials are still molten, e.g., not solidified. As shown in example system 200, a first roller may be in contact with a first layer, wherein the first layer may be the molten sheet of conductive thermoplastic, and a second roller may be in contact with a second layer, wherein the second layer may be molten nonconductive thermoplastic ribs. The chilling rollers 216 may be cooled, e.g., via liquid, so that they may be cooler than the materials to initiate solidification of the materials as the materials come into contact with the chilling rollers 216. By pressing the molten materials together while cooling with the chilling rollers 216, the materials may become a bonded product (mechanically and/or chemically) as they solidify, forming a continuous structure, wherein a plurality of ribs are protruding from the bipolar plate, which may be cooled in a cooling bath 218. The bonded product may be cut according to target dimensions to yield bipolar plates with an integrated negative electrode spacer.

The nonconductive thermoplastic ribs of the negative electrode spacer may extend across a surface of the bipolar plate according to a direction of extrusion, as indicated by arrows 214 of FIG. 2. An example of a bipolar plate 300 formed by the system 200 of FIG. 2 is depicted in FIG. 3. The bipolar plate 300 comprises a graphite/polypropylene sheet 302 (although the shect may be formed of some other conductive thermoplastic composite) with ribs 304 extending across a surface (e.g., a negative side) of the bipolar plate 300. The ribs extend along a length 306 of the bipolar plate 300, where the length 306 is parallel with a direction of extrusion of the bipolar plate 300, as indicated by arrow 301. The ribs 304 may be formed of a nonconductive thermoplastic, such as polypropylene (or some other compatible nonconductive polymer), and may form a negative electrode spacer integrated into the surface of the bipolar plate 300. The ribs 304 may be oriented parallel with one another and may be spaced evenly apart along a width 308 of the bipolar plate. In one example, a distancing between the ribs 304 may be selected to maximize a volume of electrolyte maintained within a negative electrode compartment formed, in part, by the bipolar plate 300 and the negative electrode spacer. A detailed view of a portion of the bipolar plate 300, as indicated by dashed rectangle 310, is illustrated in FIG. 4.

As shown in FIG. 4, the ribs 304 may have a rectangular profile, both along the direction of extrusion, as indicated by arrow 301, and in a direction perpendicular to the direction of extrusion. A shape profile of the ribs 304 may be varied, however, according to a desired effect on electrolyte flow across the surface of the bipolar plate 300. For example, the profile of the ribs 304 along the width (e.g., the width 308 as indicated in FIG. 3), of the bipolar plate may be another shape besides rectangular, such as square, triangular, or rectangular with curved corners. Side walls of the ribs 304 (e.g., sides of the ribs extending perpendicularly away from the graphite/polypropylene sheet 302) may be curved or sinuous instead of planar. A width 402 of cach of the ribs 304 may or may not be uniform along its height 404. As examples, the width 402 of one or more of the ribs 304 may be tapered along the height 404 or may vary in a curvilinear manner. A geometry of the ribs 304 along the length (e.g., the length 306 indicated in FIG. 3) of the bipolar plate 300 may also deviate from linear, in other examples, and instead be sinuous or angled. For example, the orientation of nonconductive thermoplastic ribs in an extrusion process (e.g. extrusion system 200 of FIG. 2) may be oscillated perpendicularly to the direction of extrusion (e.g. direction as indicated by arrows 214 of FIG. 2), creating sinusoidal curved ribs along the length of the bipolar plate 300. Sinusoidal curved ribs may increase electrolyte mixing compared to linear ribs. Thus, the shape of the ribs 304 may not be linear depending on desired electrolyte flow, and orientation of the nonconductive thermoplastic ribs during extrusion may be altered to achieve the corresponding geometry of ribs.

Furthermore, a spacing of the ribs 304, e.g., a distance 406 between adjacent ribs 304, may be varied to become wider or narrower than depicted in FIGS. 3 and 4, or may not be uniform across the width of the bipolar plate 300, or may vary along the length of the bipolar plate 300. The spacing may be optimized to maximize an active area of the bipolar plate 300 while minimizing an amount of material used to form the bipolar plate 300. In addition, the spacing may be selected to provide sufficient flow volume for a desired amount of electrolyte to flow through the negative electrode compartment that is at least partially enclosed by the surface of the bipolar plate 300 with the ribs 304. In yet other examples, side surfaces of the ribs 304 may be textured or smooth.

The ribs 304 of the negative electrode spacer may be positioned between the graphite/polypropylene sheet 302 and a membrane separator of an electrode assembly, where a positive electrode may be arranged on an opposite side of the membrane separator from the ribs 304. Upon installation in a power module of a battery system, such as the power module 120 of FIG. 1, the electrode assembly may be compressed between pressure plates, which may aid in sealing fluids within the electrode assembly. It will be appreciated that, as described previously, the power module may include a plurality of electrode assemblies arranged in a stack, with the plurality of electrode assemblies sandwiched between the pressure plates in series. Upper surfaces 408 of the ribs 304 may be in face-sharing contact with the membrane separator, the spaces between the plurality of ribs forming discrete flow channels 410 (e.g., electrolyte flow channels) along the surface of the bipolar plate 300 that are sealed from one another. In other words, electrolyte flowing through the flow channels 410 may not be exchanged between the flow channels 410.

In some instances, electrolyte exchange between the flow channels 410 may be desirable to promote mixing and increase plating uniformity, homogeneity, and resistance to flaking (e.g., hereafter referred to as plating quality). To promote electrolyte mixing while providing sufficient structural support to maintain the desired flow volume of the negative electrode compartment, the upper surfaces of at least a portion of the ribs 304 may be modified to allow the correspondingly adjacent flow channels 410 to be fluidically coupled.

In one example, as shown in FIG. 5, a second example of a system 500 for co-extruding a bipolar plate with a negative electrode spacer may be configured to produce modified ribs. For example, the ribs may be dimpled to provide openings in the ribs, when the bipolar plate and the negative electrode spacer are incorporated into an electrode assembly of a power module, through which electrolyte may be exchanged. The system 500 includes components in common with the system 200 of FIG. 2, which will not be re-introduced for brevity.

The conductive thermoplastic sheet 204 and the nonconductive thermoplastic ribs 208 may be extruded by feeding through the first die 210 and the second die 212, respectively, as described above with reference to FIG. 2. The conductive thermoplastic sheet 204 may further be textured on one side by passing through the set of rollers 220 while molten. While still molten, the thermoplastics may be pressed together for mechanical and/or chemical bonding by a set of chilling rollers 502, including a first roller 502a and a second roller 502b. The first roller 502a may be in contact with the conductive thermoplastic sheet 204, along a surface of a positive side of a resulting bipolar plate formed of the conductive thermoplastic sheet 204, and may have a smooth outer surface. The second roller 502b may have a plurality of ridges 504 protruding outwards from a surface of the second roller 502b, around a circumference of the second roller 502b, wherein the plurality of ridges 504 protruding outward onto the plurality of ribs imprint dimples onto the ribs of the negative electrode spacer as the co-extruded conductive thermoplastic sheet and nonconductive thermoplastic ribs are passed through the set of chilling rollers 502.

In one example, the plurality of ridges 504 may extend entirely across a width of the second roller 502b, the width defined along a direction perpendicular to the direction of co-extrusion indicated by arrows 214. As such, each of the ribs of the negative electrode spacer may be similarly dimpled. In another example, the plurality of ridges 504 may have variable dimensions. For example, a portion of the plurality of ridges 504 may extend across less than the entire width of the second roller 502b, resulting in some of the ribs of the negative electrode spacer having more imprinted dimples than others. In yet another example, all of the plurality of ridges 504 may be abbreviated to extend across a portion of the width of the second roller 502b and may be staggered relative to one another such that the imprinted dimples of the ribs are offset across the surface of the bipolar plate. In each example, the exchange of electrolyte between flow channels through the spaces formed by the dimples is controlled in a different flow pattern. Numerous possible variations in a configuration of the dimples are possible without departing from the scope of the present disclosure.

An example of a bipolar plate 600 with an integrated negative electrode spacer is shown in FIG. 6, where the bipolar plate 600 may be fabricated via the system 500 of FIG. 5. The bipolar plate 600 includes a graphite/polypropylene sheet 602 (or some other conductive thermoplastic composite), for example, with ribs 604 extending along a negative side surface of the graphite/polypropylene sheet 602. The ribs 604, as described above, may be formed of polypropylene, as an example, and may be oriented parallel with one another along a length 606 of the bipolar plate 600, the length aligned with a direction of extrusion of the bipolar plate 600.

The ribs 604 may include dimples 608, which may be regions of the ribs 604 where a height 610 (e.g. distance of protruding from the bipolar plate) of the ribs 604 is decreased. When installed in an electrode assembly, upper surfaces 612 of the ribs 604 that are adjacent to the dimples 608 along a given rib (e.g., regions of the ribs 604 where the height 610 is not decreased) may be in face-sharing contact with a first face of a membrane separator, the first face opposite of a second face of the membrane separator in contact with a positive electrode of the electrode assembly. The dimples 608 may form openings in the ribs 604 when the bipolar plate 600 is coupled to the membrane separator, that allow electrolyte flowing through flow channels 614 of the bipolar plate 600 to be exchanged between adjacent flow channels 614. In other words, electrolyte flowing through one of the flow channels 614 may flow into an adjacent flow channel through one or more of the dimples 608 in one of the ribs 604 extending between the adjacent flow channels. For example, while a primary flow direction, e.g., a predominant direction of electrolyte flow, may be parallel with the length 606 of the bipolar plate 600, secondary flow of the electrolyte along a direction perpendicular to the length 606 of the bipolar plate 600 may be enabled. The dimples 608 therefore provide fluidic coupling of the flow channels 614 to one another, allowing the electrolyte to be mixed across an active area of the bipolar plate 600. Mixing of the electrolyte may be further promoted by changing the geometry of the ribs 604 to be sinusoidal, for example, rather than parallel as discussed in regards to FIG. 4 above. Mixing of the electrolyte may allow active materials of the electrolyte (e.g., redox active species), to be distributed more homogenously across the active area.

In another example, manufacturing efficiency may be further increased by coupling a membrane separator and a positive electrode to a co-extruded bipolar plate and negative electrode separator during a fabrication process to form a membrane-electrode assembly (MEA). A third example of a system 700 for co-extruding a bipolar plate with a negative electrode spacer is shown in FIG. 7, where the system also includes direct attachment of a membrane separator and a positive electrode, to a co-extruded sheet with ribs. The system 700 includes components in common with the system 200 and system 500 of FIGS. 2 and 5, respectively, which will not be re-introduced for brevity.

As illustrated in FIG. 7, the system 700 includes a felt roll 702 and a membrane material roll 704, in addition to the first extruder 202 and second extruder 206, for forming a third layer and fourth layer of a MEA. The felt roll 702 may be a roll of felt 706 for forming a positive electrode of the MEA and the membrane material roll 704 may be a roll of a membrane material 708 for forming a membrane separator of the MEA. The felt 706 may be a carbon or graphite felt, for example, and the membrane material 708 may be any material suitable for use in the MEA. The felt roll 702 may be positioned such that the felt 706 may be coupled to a surface of the conductive thermoplastic sheet 204 opposite of a surface to which the ribs formed by the nonconductive thermoplastic ribs 208 may be bonded. The membrane material roll 704 may be positioned such that the membrane material 708 may be coupled to an opposite surface of the ribs formed by the nonconductive thermoplastic ribs 208 from the conductive thermoplastic sheet 204. For example, from the perspective shown in FIG. 7, the felt roll 702 may be arranged above the first extruder 202 with first die 210, the first extruder 202 with first die 210 above the second extruder 206 with the second die 212, and the second extruder 206 with second die 212 above the membrane material roll 704.

The nonconductive thermoplastic ribs 208 and the conductive thermoplastic sheet 204 may be co-extruded as described above, with reference to FIG. 2. Although not shown in FIG. 7, the conductive thermoplastic may also be textured (e.g., with rollers similar to rollers 220 of FIG. 2) following extrusion through die 210 and prior to contacting other materials. Concurrent with the co-extrusion, the felt 706 and the membrane material 708 may be conveyed to the chilling rollers 216 where the layers of the MEA may be bonded and/or adhered to one another by feeding the four layers through the chilling rollers 216. For example, the layers may be stacked, e.g., brought into contact with one another, and as the layers pass between the chilling rollers 216, the still-molten conductive thermoplastic sheet 204 and nonconductive thermoplastic ribs 208 may be pressed against the felt 706 and the membrane material 708, respectively, and adhere to the respective layers (as well as to one another) as the molten materials cool and begin to solidify.

Upon cooling the bonded layers in the cooling bath 218, the conductive thermoplastic sheet 204 and nonconductive thermoplastic ribs 208 may fully solidify and the layers of the MEA may be adhered to one another. The stacked layers may be cut according to target dimensions for the MEA. By co-extruding the bipolar plate with the negative electrode spacer and concurrently layering the felt and the membrane material with the layers to be extruded, a number of processing steps demanded for manufacturing of the MEA may be reduced. In examples where the negative electrode spacer is to be dimpled (e.g., as shown in FIGS. 5-6), the membrane material roll 704 may not be included in the system 700, and instead added to the stack after the felt and the bipolar plate with the integrated negative electrode spacer are pressed between the chilling rollers 216. Further, in other examples, the membrane of the MEA may be fabricated by a separate extrusion process and coated with a film to promote ion crossover and/or ion selectivity, such as a perfluorosulfonic acid/polytetrafluoroethylene copolymer, during manufacturing steps executed by the system 700. By promoting ion crossover and/or ion selectivity through coating a film onto the membrane layer, fouling of the membrane may be reduced.

An example of a MEA 800 which may be formed by any of the processes shown in FIG. 2, 5, or 7, is illustrated in a cross-sectional view in FIG. 8. The MEA 800 is included in a battery stack 802 formed of more than one MEA stacked along an axis perpendicular to a plane of the MEA layers. The MEA 800 includes a membrane separator 804, a negative electrode spacer 806 (e.g., a rib thereof is depicted in FIG. 8), a bipolar plate 808, and a positive electrode 810. The bipolar plate 808 is supported by a frame plate 812, and the MEA 800 includes additional supports and frames 814 for providing structural integrity to the battery stack 802.

The bipolar plate 808 may be co-extruded with the negative electrode spacer 806 such that the negative electrode spacer 806 and the bipolar plate 808 form a single continuous structure. The membrane separator 804 may be in face-sharing contact with edge surfaces of the negative electrode spacer 806, as well as with a positive electrode of an adjacent MEA, and the positive electrode may in face-sharing contact with the bipolar plate 808, as well as with a membrane of an adjacent MEA.

A direction of negative electrolyte flow through a negative electrode compartment of the MEA is indicated by arrow 816. The negative electrode compartment includes a volume formed between the bipolar plate 808 and the membrane separator 804, with the negative electrode spacer 806 extending therethrough, parallel with the direction of negative electrolyte flow. The negative electrode spacer 806 therefore is in direct contact with the negative electrolyte and a surface profile, texture, geometry, etc., of the negative electrode spacer 806 may affect the flow. For example, turbulence in the flow may be increased to enhance mixing between flow channels partitioned by the negative electrode spacer 806 by incorporating openings in the negative electrode spacer ribs to allow electrolyte to be exchanged between flow channels. By integrating the negative electrode spacer 806 with the bipolar plate 808, misalignment or omission of the negative electrode spacer 806 during manufacturing may be mitigated.

An example of a method 900 for fabricating a bipolar plate with an integrated negative electrode spacer is shown in FIG. 9. The method may be conducted at least in part by manufacturing equipment arranged along an assembly line at a production facility. The manufacturing equipment may be fully automated or manually controlled or a combination thereof, and execution of the method may be achieved by any of the systems of FIG. 2, 5, or 7.

At 901 the method includes co-extruding layers of an electrode assembly, such as a MEA. The layers may include a conductive thermoplastic, such as graphite loaded with polypropylene, and a nonconductive thermoplastic, such as polypropylene. The layers may be extruded through respective dies, as shown in FIGS. 2, 5, and 7, with the conductive thermoplastic co-extruded as a sheet to form bipolar plates, and the nonconductive thermoplastic extruded as ribs or strands of a negative electrode spacer arranged parallel with a direction of extrusion. The ribs may be extruded with a selected geometry and selected dimensions with a desired spacing between the ribs. In some examples, orientation of the ribs may be oscillated, thereby forming a sinusoidal rib shape along a flow path of the electrode assembly.

In some examples, at 902, method 900 includes texturing the conductive thermoplastic sheet. For example, the conductive thermoplastic sheet may be fed through rollers while molten, as shown in FIGS. 2 and 5, where one roller is rough so that roughness may be imprinted onto a surface of the conductive thermoplastic sheet. The rough roller (e.g., roller 220b) may have a selected level of roughness to increase plating adhesion on a bipolar plate made of the conductive thermoplastic sheet.

In some examples, at 903, method 900 includes feeding the layers that may not be extruded layers. For example, the non-extruded layers may include a membrane material, for forming a membrane separator of the MEA, and a felt for forming a positive electrode of the MEA. The membrane material and the felt may be provided as rolls which may be fed along the assembly line with the conductive thermoplastic and the nonconductive thermoplastic. For example, the membrane material and the felt may be coupled to the co-extruded bipolar plate and the negative electrode spacer immediately after co-extrusion. The co-extruded layers and optionally the layers provided by rolls may form a stack, including stacked layers as shown in FIGS. 7-8.

At 904, the method includes pressing the layers between chilling rollers, such as the chilling rollers 216 of FIGS. 2 and 7, or 502 of FIG. 5. The chilling rollers may be cooled to a temperature lower than a temperature of the extruded layers which may still be molten upon passing between the chilling rollers. Upon contacting the chilling rollers, the layers may be cooled and may bond to one another upon solidification. For example, when the layers are the conductive thermoplastic and the nonconductive thermoplastic, the layers may adhere to one another upon cooling. In one example, at least one of the chilling rollers, e.g., a chilling roller in contact with the nonconductive thermoplastic, may be configured with ridges to imprint dimples into the negative electrode spacer, as shown in FIGS. 5 and 6.

In instances where the layers include the felt and the membrane material, in addition to the conductive thermoplastic and the nonconductive thermoplastic, the molten conductive thermoplastic and nonconductive thermoplastic may solidify upon contact with the chilling rollers and bond with one another, as well as the felt and the membrane material, respectively. Subsequent processing to incorporate the positive electrode and the membrane separator may thereby be obviated.

At 906, the method includes cooling the bonded layers (e.g., the stack) of the MEA. For example, the layers, comprising either the conductive thermoplastic bonded with the nonconductive, or the positive electrode, the conductive thermoplastic, the nonconductive thermoplastic, and the membrane separator bonded in the stack, or any other combination of the four layers, may be passed through a cooling bath filled with a cooling fluid, such as water. By passing the layers through the cooling bath, the conductive thermoplastic and the nonconductive thermoplastic may be further solidified and the layers may undergo a maximum amount of contraction, which may compel stronger bonding between the layers. After the layers are cooled, the bonded layers are cut according to target dimensions at 908 of the method. For example, the layers may be cut according to available packaging space for MEAs within a power module of a battery system.

In this way, a manufacturing process for a MEA may be streamlined by co-extruding a bipolar plate and a negative electrode spacer of the MEA. By co-extruding the bipolar plate with the negative electrode spacer, placement and alignment by an automated process or by an operator of the negative electrode spacer after extrusion of the bipolar plate may be excluded from the manufacturing process. A likelihood of misalignment, or inadvertent omission of the negative electrode spacer may be reduced. The co-extrusion maintains an ability to adjust a spacing, geometry, contour, profile, etc. of the negative electrode spacer, allowing electrolyte flow across the bipolar plate to be moderated based on the negative electrode spacer configuration. Further, in some examples, the MEA may be manufactured via a single assembly process by layering the co-extruded bipolar plate and negative electrode spacer with a membrane separator and a positive electrode along the assembly line, after co-extrusion and prior to pressing the layers between chilling rollers. As a result, the manufacturing process may be more efficient and more reproducible.

The disclosure also provides support for a method for manufacturing an electrode assembly, comprising: co-extruding a first layer, comprising a conductive thermoplastic, with a second layer, comprising a nonconductive thermoplastic, to form a stack, pressing the stack between a set of rollers, and cooling the stack to provide a bipolar plate with an integrated negative electrode spacer bonded to a first surface of the bipolar plate. In a first example of the method, the first layer forms the bipolar plate and the second layer forms the integrated negative electrode spacer, and wherein co-extruding the first layer and the second layer includes extruding the first layer through a first extruder and a first die and extruding the second layer through a second extruder and a second die, and contacting the first layer with the second layer while the first layer and the second layer are molten. In a second example of the method, optionally including the first example, the set of rollers are cooler than the first layer and the second layer when the first layer and the second layer are molten, and wherein the stack is cooled when the stack is passed between the set of rollers. In a third example of the method, optionally including one or both of the first and second examples, cooling the stack includes passing the stack through a cooling bath to fully solidify and bond the stack. In a fourth example of the method, optionally including one or more or each of the first through third examples, a first roller of the set of rollers has a plurality of ridges arranged around a circumference of the first roller, the first roller configured to contact the second layer, and wherein passing the stack between the set of rollers includes imprinting dimples into the second layer via the first roller. In a fifth example of the method, optionally including one or more or each of the first through fourth examples, the method further comprises: feeding a third layer, formed of a felt, and feeding a fourth layer, formed of a membrane material, to the stack after co-extruding the first layer and the second layer and before passing the stack through the set of rollers, and wherein the third layer forms a positive electrode and the fourth layer forms a membrane separator. In a sixth example of the method, optionally including one or more or each of the first through fifth examples, the third layer is coupled to a second surface of the first layer, opposite of the first surface, and the fourth layer is coupled to a surface of the second layer, opposite of the first layer. In a seventh example of the method, optionally including one or more or each of the first through sixth examples, the method further comprises: coating the fourth layer with a film during formation of the stack, the film configured to promote ion crossover and ion selectivity in the membrane separator. In a eighth example of the method, optionally including one or more or each of the first through seventh examples, the method further comprises: texturing the first layer before forming the stack, wherein the texturing is configured to promote plating on the provided bipolar plate. In a ninth example of the method, optionally including one or more or each of the first through eighth examples, co-extruding the second layer includes oscillating the second layer to form a sinusoidal rib shape with respect to a flow path of the provided bipolar plate.

The disclosure also provides support for an electrode assembly for a battery system, comprising: a bipolar plate with an integrated negative electrode spacer, the integrated negative electrode spacer formed of ribs and mechanically or chemically bonded to a surface of the bipolar plate. In a first example of the system, the integrated negative electrode spacer is formed of a nonconductive thermoplastic and the bipolar plate is formed of a conductive thermoplastic. In a second example of the system, optionally including the first example, the nonconductive thermoplastic is polypropylene and the conductive thermoplastic is graphite loaded with polypropylene. In a third example of the system, optionally including one or both of the first and second examples, the bipolar plate with the integrated negative electrode spacer is a single continuous structure formed by co-extrusion, and wherein the integrated negative electrode spacer comprises a plurality of ribs protruding from the surface of the bipolar plate. In a fourth example of the system, optionally including one or more or each of the first through third examples, the plurality of ribs extend across the surface of the bipolar plate along a direction of co-extrusion, and wherein flow channels are defined by spaces between the plurality of ribs. In a fifth example of the system, optionally including one or more or each of the first through fourth examples, the plurality of ribs includes dimples along an upper surface of the plurality of ribs, the upper surface configured to be face-sharing contact with a membrane separator. In a sixth example of the system, optionally including one or more or each of the first through fifth examples, the dimples form openings in the plurality of ribs when the membrane separator is coupled to the integrated negative electrode spacer, and wherein electrolyte is exchanged between the flow channels through the openings by flowing through the openings in a direction perpendicular to the direction of co-extrusion.

The disclosure also provides support for a method for fabricating a bipolar plate with an integrated negative electrode spacer, comprising: forming a continuous structure from a conductive thermoplastic sheet with nonconductive thermoplastic ribs extending in parallel across a surface of the conductive thermoplastic sheet along a direction of co-extrusion of the continuous structure. In a first example of the method, the continuous structure is formed by extruding the conductive thermoplastic sheet through a first extruder while extruding the nonconductive thermoplastic ribs through a second extruder, concurrent with extrusion of the conductive thermoplastic sheet, layering the nonconductive thermoplastic ribs across the surface of the conductive thermoplastic sheet while each of the nonconductive thermoplastic ribs and the conductive thermoplastic sheet are molten, and cooling the continuous structure to solidify the continuous structure and bond the nonconductive thermoplastic ribs to the conductive thermoplastic sheet. In a second example of the method, optionally including the first example, the bipolar plate with the integrated negative electrode spacer is used in a redox flow battery system.

FIGS. 3, 4, 6, and 8 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. FIGS. 3, 4, 6, and 8 are drawn approximately to scale, although other dimensions or relative dimensions may be used.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for manufacturing an electrode assembly, comprising:
co-extruding a first layer, comprising a conductive thermoplastic, with a second layer, comprising a nonconductive thermoplastic, to form a stack;
pressing the stack between a set of rollers; and
cooling the stack to provide a bipolar plate with an integrated negative electrode spacer bonded to a first surface of the bipolar plate.

2. The method of claim 1, wherein the first layer forms the bipolar plate and the second layer forms the integrated negative electrode spacer, and wherein co-extruding the first layer and the second layer includes extruding the first layer through a first extruder and a first die and extruding the second layer through a second extruder and a second die, and contacting the first layer with the second layer while the first layer and the second layer are molten.

3. The method of claim 2, wherein the set of rollers are cooler than the first layer and the second layer when the first layer and the second layer are molten, and wherein the stack is cooled when the stack is passed between the set of rollers.

4. The method of claim 1, wherein cooling the stack includes passing the stack through a cooling bath to fully solidify and bond the stack.

5. The method of claim 1, wherein a first roller of the set of rollers has a plurality of ridges arranged around a circumference of the first roller, the first roller configured to contact the second layer, and wherein passing the stack between the set of rollers includes imprinting dimples into the second layer via the first roller.

6. The method of claim 1, further comprising feeding a third layer, formed of a felt, and feeding a fourth layer, formed of a membrane material, to the stack after co-extruding the first layer and the second layer and before passing the stack through the set of rollers, and wherein the third layer forms a positive electrode and the fourth layer forms a membrane separator.

7. The method of claim 6, wherein the third layer is coupled to a second surface of the first layer, opposite of the first surface, and the fourth layer is coupled to a surface of the second layer, opposite of the first layer.

8. The method of claim 7, further comprising coating the fourth layer with a film during formation of the stack, the film configured to promote ion crossover and ion selectivity in the membrane separator.

9. The method of claim 1, further comprising texturing the first layer before forming the stack, wherein the texturing is configured to promote plating on the provided bipolar plate.

10. The method of claim 1, wherein co-extruding the second layer includes oscillating the second layer to form a sinusoidal rib shape with respect to a flow path of the provided bipolar plate.

11. An electrode assembly for a battery system, comprising:
a bipolar plate with an integrated negative electrode spacer, the integrated negative electrode spacer formed of ribs and mechanically or chemically bonded to a surface of the bipolar plate.

12. The electrode assembly of claim 11, wherein the integrated negative electrode spacer is formed of a nonconductive thermoplastic and the bipolar plate is formed of a conductive thermoplastic.

13. The electrode assembly of claim 12, wherein the nonconductive thermoplastic is polypropylene and the conductive thermoplastic is graphite loaded with polypropylene.

14. The electrode assembly of claim 11, wherein the bipolar plate with the integrated negative electrode spacer is a single continuous structure formed by co-extrusion, and wherein the integrated negative electrode spacer comprises a plurality of ribs protruding from the surface of the bipolar plate.

15. The electrode assembly of claim 14, wherein the plurality of ribs extend across the surface of the bipolar plate along a direction of co-extrusion, and wherein flow channels are defined by spaces between the plurality of ribs.

16. The electrode assembly of claim 15, wherein the plurality of ribs includes dimples along an upper surface of the plurality of ribs, the upper surface configured to be face-sharing contact with a membrane separator.

17. The electrode assembly of claim 16, wherein the dimples form openings in the plurality of ribs when the membrane separator is coupled to the integrated negative electrode spacer, and wherein electrolyte is exchanged between the flow channels through the openings by flowing through the openings in a direction perpendicular to the direction of co-extrusion.

18. A method for fabricating a bipolar plate with an integrated negative electrode spacer, comprising:
forming a continuous structure from a conductive thermoplastic sheet with nonconductive thermoplastic ribs extending in parallel across a surface of the conductive thermoplastic sheet along a direction of co-extrusion of the continuous structure.

19. The method of claim 18, wherein the continuous structure is formed by extruding the conductive thermoplastic sheet through a first extruder while extruding the nonconductive thermoplastic ribs through a second extruder, concurrent with extrusion of the conductive thermoplastic sheet, layering the nonconductive thermoplastic ribs across the surface of the conductive thermoplastic sheet while each of the nonconductive thermoplastic ribs and the conductive thermoplastic sheet are molten, and cooling the continuous structure to solidify the continuous structure and bond the nonconductive thermoplastic ribs to the conductive thermoplastic sheet.

20. The method of claim 18, wherein the bipolar plate with the integrated negative electrode spacer is used in a redox flow battery system.
